(19) United States
(12) Patent Application Publication
(10) Pub. No.: US 2022/0277330 A1
(43) Pub. Date: Sep. 1, 2022

(54) METHOD AND SYSTEM FOR PRODUCT PROCESSING PRICE PREDICTION BASED ON MULTIPLE REGRESSION MODEL

(71) Applicant: STAR RAPID MANUFACTURING LIMITED, Zhongshan City, Guangdong (CN)

(72) Inventors: William George STYLES, Zhongshan City (CN); Manjeet SINGH, Zhongshan City (CN); Gordon STYLES, Zhongshan City (CN)

(73) Assignee: STAR RAPID MANUFACTURING LIMITED, Zhongshan City, Guangdong (CN)

(21) Appl. No.: 17/626,274

(22) PCT Filed: Oct. 9, 2020
(86) PCT No.: PCT/CN2020/119901

§ 371 Date: Jan. 11, 2022

(30) Foreign Application Priority Data
Jun. 15, 2020 (CN) 202010545222.7

(51) Int. Cl. G06Q 30/02; G06F 17/18; G06K 9/62

(52) U.S. Cl. CPC G06Q 30/0206; G06F 17/18; G06K 9/6256

(57) ABSTRACT

A method and system for product processing price prediction based on multiple regression model includes: gathering multiple product data, building product original dataset, the data includes product quantity, surface area, processing complexity, product X axis length, product Y axis length, product Z axis length, tool utilization rate, product tolerance level, product machinability, material unit price, material density and price; building a multiple linear regression model based on the product original dataset; the product original dataset is divided into a training subset and a testing subset, the multiple linear regression model is trained through the training subset, the accuracy of the multiple linear regression model is verified by the testing subset, and the multiple linear regression model is adjusted according to the testing result to determine the final multiple linear regression model. The product processing price in predicted based on the artificial intelligence algorithm, which improves the accuracy of the quotation.

### TECHNICAL FIELD

The invention relates to the technical field of automatic machining, in particular to method and system for product processing price prediction based on multiple regression model.

### BACKGROUND ART

CNC machining usually refers to computer digital control precision machining, the corresponding machining equipment includes CNC lathes, CNC milling machines and CNC boring-milling machines, etc., which have the advantages of reducing the number of tooling, high machining accuracy and high machining efficiency, and have been widely used in industry.

The quotation of products processed by CNC equipment has always lacked a standardized and effective way. In the prior art, the feasible quoting method is manual quotation, quoters predict the product processing time, product material price and surface treatment cost based on historical experience and understanding of the industry, and finally synthesize the above costs to obtain the product quotation. This quoting method is too subjective, and it is inevitable that there are problems with high or low quotes. Therefore, the prior art urgently needs a standardized and accurate quoting method.

### SUMMARY OF THE INVENTION

The invention provides a method and system for product processing price prediction based on multiple regression model, which predicts the product processing price based on an artificial intelligence algorithm and improves the accuracy of quoting.

According to the first aspect of the invention, the invention provides a method for product processing price prediction based on multiple regression model, comprising the following steps:

Gathering multiple product data, building a product original dataset, the product data comprises product quantity, product surface area, product processing complexity, product X axis length, product Y axis length, product Z axis length, tool utilization rate, product tolerance level, product machinability, material unit price, material density and price;

building a multiple linear regression model based on the product original dataset, the formula of the multiple linear regression model is:

log(y)=β₀+log(x₁)+log(x₂)+x₃+x₄+x₅+x₆+x₇+x₈+x₉+x₁₀+x₁₁;

therein, y is price, β₀ is a constant term, x₁-x₁₁ are product quantity, product surface area, product processing complexity, product X axis length, product Y axis length, product Z axis length, tool utilization rate, product tolerance level, product machinability, material price per KG and material density;

the product original dataset is divided into at least a training subset and at least a testing subset, the multiple linear regression model is trained through the training subset, the accuracy of the multiple linear regression model is verified by testing subset, and the multiple linear regression model is adjusted according to the validation result to determine the final multiple linear regression model.

Preferably, the multiple linear regression model is trained through the training subset, the accuracy of the multiple linear regression model is verified by the testing subset, specifically: the constant term in the multiple linear regression model is obtained through training by the training subset, the product data of the testing subset is substituted into the multiple linear regression model with the determined constant term value, and the accuracy of the multiple linear regression model is determined according to the output result of the multiple linear regression model.

Preferably, after substituting the product data of the testing subset into the multiple linear regression model with the determined constant term value, if the difference between the price output by the multiple linear regression model and the price in the testing subset is greater than the predetermined difference, the multiple linear regression model is adjusted according to the difference.

Preferably, it further comprises the following steps: building a testing dataset, and using the testing dataset to test the accuracy of the multiple linear regression model.

Preferably, the product tolerance level and the product tolerance value have a preset mapping relationship, the product processing complexity is the product processing complexity level, and the product machinability is the product machinability level.

According to the second aspect of the invention, the invention provides a system for product processing price prediction based on multiple regression model, comprising:

a data collection module for collecting multiple product data and building product original dataset, the product data comprises product quantity, product surface area, product processing complexity, product X axis length, product Y axis length, product Z axis length, tool utilization rate, product tolerance level, product machinability, material unit price, material density and price;

a model building module for building multiple linear regression model based on the product original dataset, the formula of the multiple linear regression model is:

log(y)=β₀+log(x₁)+log(x₂)+x₃+x₄+x₅+x₆+x₇+x₈+x₉+x₁₀+x₁₁

therein, y is price, β₀ is constant term, x₁-x₁₁ are product quantity, product surface area, product processing complexity, product X axis length, product Y axis length, product Z axis length, tool utilization rate, product tolerance level, product machinability, material unit price and material density respectively;

a validation module for dividing the product original dataset into training subset and testing subset, the multiple linear regression model is trained through the training subset, the accuracy of the multiple linear regression model is verified by testing subset, and the multiple linear regression model is adjusted according to the validation result to determine the final multiple linear regression model.

Preferably, the validation module is used to obtain the constant term in the multiple linear regression model through training by the training subset, substitute the product data in the testing subset into the multiple linear regression model with the determined constant term value, and determine the accuracy of the multiple linear regression model according to the output result of the multiple linear regression model.

Preferably, the validation module is used to, after substituting the product data in the testing subset into the multiple linear regression model with the determined constant term value, if the difference between the price output by the multiple linear regression model and the price in the testing subset is greater than the predetermined difference, adjust the multiple linear regression model according to the difference.

Preferably, the system for product processing price prediction based on multiple regression model further comprises a data testing module for building testing dataset, and using the testing dataset to test the accuracy of the multiple linear regression model.

Preferably, the product tolerance level and the product tolerance value have a preset mapping relationship, the product processing complexity is product processing complexity level, and the product machinability is product machinability level.

The invention has the following technical effects: the invention builds a multiple linear regression model of product processing price based on a large number of original data, trains the multiple linear regression model through the training subset, verifies the accuracy of the multiple linear regression model by using the testing subset, adjusts the multiple linear regression model according to the validation results to determine the multiple linear regression model of final product processing price, changes the traditional way of manually predicting the product processing price, predicts the product processing price through the multiple linear regression model, and improves the accuracy of quotation.

### BRIEF DESCRIPTION OF THE DRAWINGS

FIG. 1 is a flowchart of a method for product processing price prediction based on multiple regression model according to an embodiment of the invention;

FIG. 2 shows a correspondence between product complexity and price of an embodiment of the invention;

FIG. 3 is a structure diagram of a system for product processing price prediction based on multiple regression model of an embodiment of the invention.

### DETAILED DESCRIPTION OF THE INVENTION

The invention will be further described in detail below through embodiments in combination with the drawings.

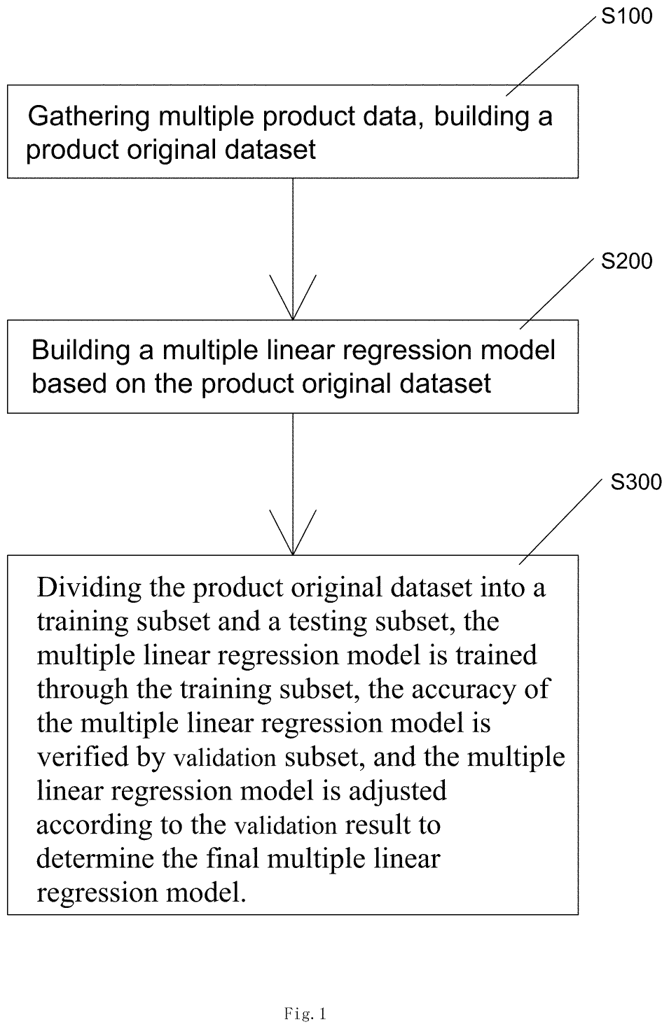

The invention provides a method for product processing price prediction based on multiple regression model, as shown in FIG. 1, which comprises the following steps:

S100: gathering multiple product data, building a product original dataset.

The product data can be derived from historical transaction data, which can be transaction data recorded by the processor or data recorded by online trading system. The amount of the product data can be determined according to the computing power of the system, the larger the data volume, the more accurate the final model, generally, the data of 1,000 products can be selected. The product data of each product includes product quantity, product surface area, product processing complexity, product X axis length, product Y axis length, product Z axis length, tool utilization rate, product tolerance level, product machinability, material unit price, material density and price.

After the product data is collected, it needs to be preprocessed to conform to the building of the learning model. Specifically, solving the missing values problem by importing median or removing a number of data points; sorting out the disordered data to make it orderly; deleting duplicate data to prevent duplicate data from affecting model calculation; using Log function to remove the skewedness of characteristic data and ensure the accuracy of data. Since the artificial intelligence learning model only accepts numeric data, the above product data are all reflected in numeric values.

After the data preprocessing is completed, the final product original dataset is built, the product original dataset includes product data such as product quantity, product surface area, product processing complexity, product X axis length, product Y axis length, product Z axis length, tool utilization rate, product tolerance level, product machinability, material unit price, material density and price of multiple products. The product original dataset will be used as the basis for modeling and data calculation.

S200: Building a multiple linear regression model based on the product original dataset.

In the product original dataset, changes in independent variables such as product quantity, product surface area, product processing complexity, product X axis length, product Y axis length, product Z axis length, tool utilization rate, product tolerance level, product machinability, material unit price and material density will all affect the price, these independent variables are highly correlated with the independent variable of price, so there is multicollinearity. Based on this, a multiple linear regression model can be built so that the independent variable of price can be linearly predicted by other independent variables, and the accuracy of this model is very high.

The formula of the above multiple linear regression model is:

log(y)=β₀+log(x₁)+log(x₂)+x₃+x₄+x₅+x₆+x₇+x₈+x₉+x₁₀+x₁₁;

among of them, y is the price, β₀ is a constant term, x₁-x₁₁ are product quantity, product surface area, product processing complexity, product X axis length, product Y axis length, product Z axis length, tool utilization rate, product tolerance level, product machinability, material unit price and material density respectively.

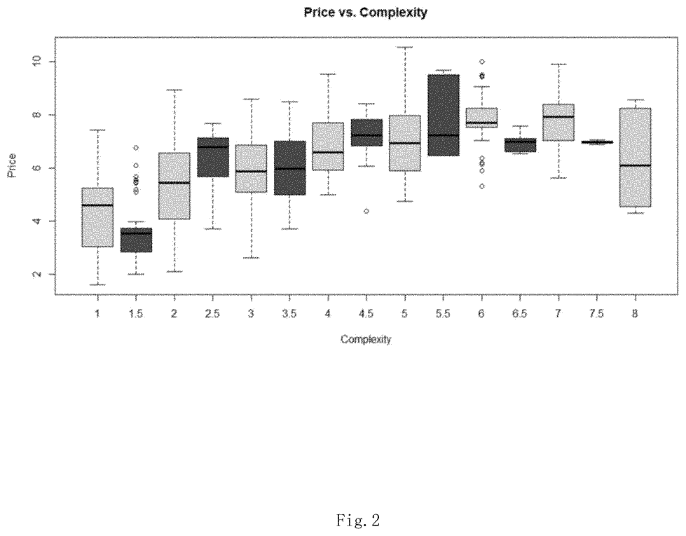

Product surface area, product X axis length, product Y axis length and product Z axis length are all positively correlated with the price, the larger the product surface area or the longer the product length, the higher the price. The product processing complexity defines the complexity based on product drawings, and the product processing complexity can be graded, which is reflected in data, for example, the product processing complexity can be defined as a range of 1-10, as shown in FIG. 2, as the complexity increases, the price will rise. The product tolerance level can be graded based on the preset product tolerance level table, each product tolerance level corresponds to a range of product tolerance. The level corresponding to the range of product tolerance is the level of product tolerance, the lower the product tolerance, the higher the price. The tool utilization rate can specifically be the ratio of the time of processing products with tools to the total processing time of products. The tools can be a variety of tools such as milling cutters and boring cutters of CNC equipments. The higher usage of the tool, the higher the price. The product quantity is positively correlated with the price, but it is not suitable for direct multiple relationship, for high-speed industrial production lines, when the number of products is larger, the unit price of product is lower, and when the number of products is smaller, the unit price of product is higher. Due to the difference in the price of different materials, the type of materials affects the cost of products in a large proportion. Some soft materials are easy to process, such as plastic and aluminum, but some hard materials are difficult to process, such as stainless steel and titanium alloy. For these very hard metals, additional costs need to be invested in processing, therefore, it takes longer to process stainless steel than to process aluminum, which will greatly increase the price of products. For some products, it is not processing the whole product, part of the product may not be processed. The smaller the proportion of products that can be processed, the less processing investment and the lower the processing price of products. Specifically, the product machinability can be reflected by the proportion of the area, weight, or volume of the processable part of the product to the corresponding area, weight, or volume of the whole product, and the product machinability can be graded and reflected in data.

S300: The product original dataset is divided into at least a training subset and at least a testing subset, the multiple linear regression model is trained through the training subset, the accuracy of the multiple linear regression model is verified by testing subset, and the multiple linear regression model is adjusted according to the validation result to determine the final multiple linear regression model.

In order to effectively verify the accuracy of the multiple linear regression model, the product original dataset is split into two subsets, a training subset and a testing subset, each of which contains product data for multiple products. The division of these two subsets depends on the total number of samples and the needs of the actual model. Some models need a lot of data to train and optimize, so the training subset contains more data. Models with fewer variables are easy to verify and adjust, which can reduce data in testing subset, however, if the models have many variables, a testing subset with a larger amount of data is required. For the multiple linear regression model, the data of the training subset and the testing subset can be divided according to a ratio of 8:2.

The multiple linear regression model is trained through the training subset, so that the multiple linear regression model performs deep learning based on the training subset. The testing subset is used to verify the accuracy of the multiple linear regression model, and adjust the multiple linear regression model according to the validation results to make the multiple linear regression model more accurate, so as to obtain the final multiple linear regression model, which can be used to predict the product processing price.

In an embodiment, in step S300, the step of training the multiple linear regression model through the training subset, and using the testing subset to verify the accuracy of the multiple linear regression model can be specifically implemented in the following manner.

Since the product surface area, product X axis length, product Y axis length, product Z axis length, product processing complexity, product tolerance level, tool utilization rate, product quantity, material density, material unit price and product machinability are all known before the product is processed, the only thing that needs to be adjusted is the constant term. Therefore, the constant term in the multiple linear regression model is obtained through training by the training subset, and then the determined multiple linear regression model with the determined constant term value is obtained, and the product data in the testing subset is substituted into the determined multiple linear regression model, the model will output a predicted price of the product, and the accuracy of the multiple linear regression model will be determined by comparing the predicted price with actual processing price of the product. The closer the predicted price is to the actual processing price of the product, the higher the accuracy.

In an embodiment, considering that the multiple linear regression model is difficult to predict the processing price of all products with 100% accuracy, it cannot be considered that the multiple linear regression model is inaccurate when the predicted price is different from the actual product price. This embodiment will set a predetermined difference, which is usually a certain ratio of the actual product price, for example, 5%-10%, after substituting the product data in the testing subset into the multiple linear regression model with the determined constant term value, calculate the difference between the price value output by the multiple linear regression model and the actual price value in the testing subset, if the difference is greater than the predetermined difference, the multiple linear regression model is considered inaccurate, and the multiple linear regression model needs to be adjusted at this time. The adjustment of the multiple linear regression model can be specifically implemented in the following manner.

The multiple linear regression model is trained through the training subset and the testing subset respectively, so that the multiple linear regression model is subjected to deep learning. Thereby, two sets of constant term values can be obtained by training, and there will be a certain difference between the two sets of constant term values. The two sets of values are respectively compared and a difference threshold is set (usually 5%-10% of the comparison data), when the difference of the compared data is less than the difference threshold, the corresponding data obtained from the training of the training subset is retained, if the difference of the compared data is greater than or equal to the difference threshold, the two data are weighted according to the proportion of the data volume of the training subset and the testing subset to obtain the final data. For example, if the difference between the constant term value obtained from the training subset training and the constant term value obtained from the testing subset training is less than the difference threshold, the constant term value in the final multiple linear regression model is the constant term value obtained from the training subset training. If the difference between the constant term value obtained from the training subset training and the constant term value obtained from the testing subset training is greater than or equal to the difference threshold, calculate the proportion of the data volume of the training subset and the testing subset, for example, 8:2, and then perform weighted calculation x=x1*80%+x2*20%, x is the constant term value in the final multiple linear regression model, x1 is the constant term value obtained from the training subset training, x2 is the constant term value obtained from the testing subset training.

In an embodiment, after step S300, the method further comprises the following steps: building a testing dataset, and using the testing dataset to test the accuracy of the multiple linear regression model. The testing dataset is an independent dataset, which is not in the product original dataset. This dataset is used to re-evaluate the final model to further verify the accuracy of the model.

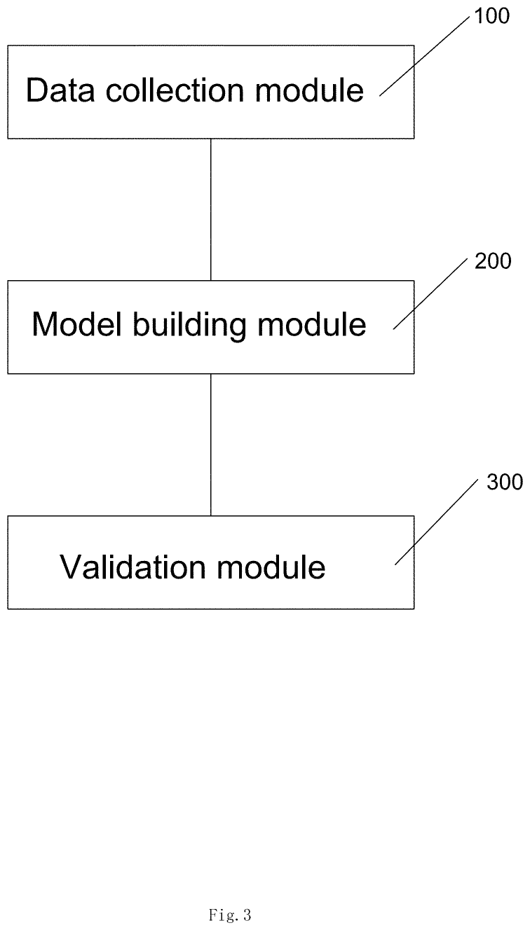

The embodiment of the invention also provides a system for product processing price prediction based on multiple regression model, as shown in FIG. 3, comprising:

a data collection module 100 for collecting multiple product data and building at least a product original dataset, the product data comprises product quantity, product surface area, product processing complexity, product X axis length, product Y axis length, product Z axis length, tool utilization rate, product tolerance level, product machinability, material unit price, material density and price;

a model building module 200 for building a multiple linear regression model based on the product original dataset, the formula of the multiple linear regression model is:

log(y)=β₀+log(x₁)+log(x₂)+x₃+x₄+x₅+x₆+x₇+x₈+x₉+x₁₀+x₁₁;

therein, y is price, β₀ is a constant term, x₁-x₁₁ are product quantity, product surface area, product processing complexity, product X axis length, product Y axis length, product Z axis length, tool utilization rate, product tolerance level, product machinability, material unit price and material density separately;

a validation module 300 for dividing the product original dataset into a training subset and a testing subset, the multiple linear regression model is trained through the training subset, the accuracy of the multiple linear regression model is verified by the testing subset, and the multiple linear regression model is adjusted according to the validation result to determine the final multiple linear regression model.

In an embodiment, the validation module 300 is used to obtain a constant term in the multiple linear regression model through training by the training subset, substitute the product data in the testing subset into the multiple linear regression model with the determined constant term value, and determine the accuracy of the multiple linear regression model according to the output result of the multiple linear regression model.

In an embodiment, the validation module is used to, after substituting the product data in the testing subset into the multiple linear regression model with the determined constant term value, if the difference between the price output by the multiple linear regression model and the price in the testing subset is greater than the predetermined difference, then adjust the multiple linear regression model according to the difference.

In an embodiment, the system for product processing price prediction based on multiple regression model further comprises a data testing module for building at least a testing dataset, and using the testing dataset to test the accuracy of the multiple linear regression model.

In an embodiment, the product tolerance level and the product tolerance value have a preset mapping relationship, the product processing complexity is the product processing complexity level, and the product machinability is the product machinability level.

Considering that the part of the system for product processing price prediction based on multiple regression model is the device content corresponding to the part of the method for product processing price prediction based on multiple regression model, the above embodiments of the system for product processing price prediction based on multiple regression model can refer to the embodiments of the method for product processing price prediction based on multiple regression model, which will not be repeated here.

The above content is a further detailed description of the invention in combination with specific embodiments, and it cannot be considered that the specific implementation of the invention is limited to these descriptions. For those of ordinary skill in the technical field to which the invention belongs, several simple deductions or substitutions can be made without departing from the concept of the invention.

What is claimed is:

1. A method for product processing price prediction based on multiple regression model, comprising the following steps:
gathering multiple product data, building a product original dataset, the product data comprises product quantity, product surface area, product processing complexity, product X axis length, product Y axis length, product Z axis length, tool utilization rate, product tolerance level, product machinability, material unit price, material density and price;
building a multiple linear regression model based on the product original dataset, the formula of the multiple linear regression model is:
log(y)=β₀+log(x₁)+log(x₂)+x₃+x₄+x₅+x₆+x₇+x₈+x₉+x₁₀+x₁₁;
therein, y is the price, β₀ is a constant term, x₁-x₁₁ are product quantity, product surface area, product processing complexity, product X axis length, product Y axis length, product Z axis length, tool utilization rate, product tolerance level, product machinability, material price per KG and material density;
dividing the product original dataset into at least a training subset and at least a testing subset, the multiple linear regression model is trained through the training subset, the accuracy of the multiple linear regression model is verified by testing subset, and the multiple linear regression model is adjusted according to the validation result to determine the final multiple linear regression model.

2. The method of claim 1, wherein the multiple linear regression model is trained through the training subset, the accuracy of the multiple linear regression model is verified by the testing subset, specifically: the constant term in the multiple linear regression model is obtained through training by the training subset, the product data of the testing subset is substituted into the multiple linear regression model with the determined constant term value, and the accuracy of the multiple linear regression model is determined according to the output result of the multiple linear regression model.

3. The method of claim 2, wherein after substituting the product data of the testing subset into the multiple linear regression model with the determined constant term value, if the difference between the price output by the multiple linear regression model and the price in the testing subset is greater than the predetermined difference, the multiple linear regression model is adjusted according to the difference.

4. The method of claim 1, wherein it further comprises the following steps: building at least a testing dataset, and using the testing dataset to test the accuracy of the multiple linear regression model.

5. The method of claim 1, wherein the product tolerance level and the product tolerance value have a preset mapping relationship, the product processing complexity is product processing complexity level, and the product machinability is product machinability level.

6. A system for product processing price prediction based on multiple regression model, comprising:
a data collection module for collecting multiple product data and building at least a product original dataset, the product data comprises product quantity, product surface area, product processing complexity, product X axis length, product Y axis length, product Z axis length, tool utilization rate, product tolerance level, product machinability, material unit price, material density and price;
a model building module for building a multiple linear regression model based on the product original dataset, the formula of the multiple linear regression model is:
log(y)=β₀+log(x₁)+log(x₂)+x₃+x₄+x₅+x₆+x₇+x₈+x₉+x₁₀+x₁₁
therein, y is the price, β₀ is a constant term, x₁-x₁₁ are product quantity, product surface area, product processing complexity, product X axis length, product Y axis length, product Z axis length, tool utilization rate, product tolerance level, product machinability, material unit price and material density;
a validation module for dividing the product original dataset into at least a training subset and at least a testing subset, the multiple linear regression model is trained through the training subset, the accuracy of the multiple linear regression model is verified by testing subset, and the multiple linear regression model is adjusted according to the validation result to determine the final multiple linear regression model.

7. The system of claim 6, wherein the validation module is used to obtain the constant term in the multiple linear regression model through training by the training subset, substitute the product data in the testing subset into the multiple linear regression model with the determined constant term value, and determine the accuracy of the multiple linear regression model according to the output result of the multiple linear regression model.

8. The system of claim 7, wherein the validation module is used to, after substituting the product data in the testing subset into the multiple linear regression model with the determined constant term value, if the difference between the price output by the multiple linear regression model and the price in the testing subset is greater than the predetermined difference, adjust the multiple linear regression model according to the difference.

9. The system of claim 6, wherein the product processing price prediction system further comprises a data testing module for building at least a testing dataset, and using the testing dataset to test the accuracy of the multiple linear regression model.

10. The system of claim 6, wherein the product tolerance level and the product tolerance value have a preset mapping relationship, the product processing complexity is the product processing complexity level, and the product machinability is the product machinability level.
